(19) United States
(12) Patent Application Publication
(10) Pub. No.: US 2017/0268378 A1
(43) Pub. Date: Sep. 21, 2017

(54) ADJUSTABLE GUIDE VANE FOR TURBOMACHINE

(71) Applicant: MTU Aero Engines AG, Munich (DE)

(72) Inventor: Alexander KLOETZER, Fuerstenfeldbruck (DE)

(21) Appl. No.: 15/450,143

(22) Filed: Mar. 6, 2017

(30) Foreign Application Priority Data
Mar. 16, 2016 (EP) 16160548.0

(51) Int. Cl. F01D 25/00; F01D 25/24; F01D 9/04; F01D 17/16

(52) U.S. Cl. CPC F01D 25/005; F01D 17/162; F01D 25/24; F01D 9/041; F05D 2240/12; F05D 2230/10; F05D 2230/232; F05D 2230/53

(57) ABSTRACT

Disclosed is an adjustable guide vane for a turbomachine, especially for a turbine stage or compressor stage of a gas turbine, which comprises a vane airfoil for deflecting a working fluid of the turbomachine and which is produced at least partially from a second material, and at least one first vane section which is produced from a first material which is different from the second material.

### CROSS-REFERENCE TO RELATED APPLICATIONS

The present application claims priority under 35 U.S.C. §119 of European Patent Application No. 16160548.0, filed Mar. 16, 2016, the entire disclosure of which is expressly incorporated by reference herein.

### BACKGROUND OF THE INVENTION

1. Field of the Invention

The present invention relates to an adjustable guide vane for a turbomachine, especially a gas turbine, to a turbomachine, in particular a gas turbine, having at least one such adjustable guide vane, and also to a method for producing such an adjustable guide vane.

2. Discussion of Background Information

Compressor stages of gas turbines with variable guide vanes are already known from intra-company experience.

In this case, vane airfoils of such adjustable guide vanes frequently have to primarily satisfy their requirements as different vane sections thereof, especially as bearing surfaces and/or as interfaces by which the guide vanes are connected to an adjustment device for adjusting the guide vanes. Whereas the former especially interact with a working fluid of the turbomachine, especially being stressed by this, the latter are to have for example better bearing properties and/or are especially to be more easily machined, especially in their ability to be cut better, for producing the interface.

If adjustable guide vanes are to be used in turbine stages, the guide vane airfoils regularly have to withstand higher temperatures than in compressor stages. In particular, such high heat-resistant materials, however, frequently have poor, or poorer, bearing properties and/or, especially for producing the interface and/or bearing surfaces, are difficult, or more difficult, in their ability to be machined, especially being poor, or poorer, in their ability to be cut.

In view of the foregoing, it is desirable to improve a turbomachine and/or its production.

### SUMMARY OF THE INVENTION

The present invention provides an adjustable guide vane for a turbomachine, especially for a turbine stage or compressor stage of a gas turbine. The guide vane comprises a vane airfoil produced at least partially from a second material for deflecting a working fluid of the turbomachine, and at least one first vane section which is produced from a first material which is different from the second material.

In one aspect, the guide vane may comprise two first vane sections which are arranged on sides of the vane airfoil which are opposite each other, at least one of the first vane sections being produced from the first material which is different from the second material.

In another aspect, the second material may feature metal and/or a superalloy and/or may be resistant to high heat and/or the first material may feature metal and/or no superalloy and/or may not be resistant to high heat and/or the yield limit or 0.2% offset yield strength of the second material may be at least about 1.1 times, especially at least about 1.5 times, the yield limit or 0.2% offset yield strength of the first material and/or the density of the second material may be at least about 1.1 times, especially at least about 1.5 times, the density of the first material.

In yet another aspect, at least one first vane section which in particular may be produced from the first material, may be machined by cutting and/or may have at least one thread.

In a still further aspect, at least one first vane section which in particular may be produced from the first material, may be joined especially in a materially bonding manner, especially by welding, especially by friction welding.

In another aspect, at least one first vane section which in particular may be produced from the first material, may comprise a radial end and/or at least a part of a bearing surface and/or of an interface for connection of an adjustment device for adjusting the guide vane.

In another aspect, at least one first vane section which in particular may be produced from the first material, may adjoin an end face or platform which delimits the vane airfoil or adjoin a second vane section which is arranged on a side of the end face or platform which is opposite the vane airfoil. For example, the platform and/or the second vane section may he produced at least partially from the second material, especially produced integrally with the vane airfoil.

The present invention also provides a turbomachine, especially a gas turbine, which comprises a casing, at least one adjustable guide vane as set forth above, especially of a turbine stage or compressor stage, which is adjustably mounted in the casing, and an adjustment device which is connected thereto for adjusting the guide vane.

The present invention also provides a method for producing the adjustable guide vane set forth above. The method comprises producing the vane airfoil from the second material; producing at least one first vane section from the first material, and connecting the vane airfoil in a materially bonding manner to the at least one first vane section.

According to one embodiment of the present invention, an adjustable guide vane for a turbomachine, especially for a turbine stage or compressor stage of a gas turbine, especially at least one adjustable guide vane for a turbomachine, especially of a turbine stage or compressor stage of a gas turbine, especially of an aviation engine, comprises a vane airfoil for variable deflection of a working fluid of the turbomachine, especially by adjustment of the guide vane, and at least one especially radial vane section and/or vane section which is different from the vane airfoil, especially arranged radially inward or radially outward from the vane airfoil, and in one embodiment has two especially radial vane sections which are arranged on sides of the vane airfoil which are opposite each other, especially radially opposite each other, which in the present case are referred to as the first vane section(s) without limiting the generality.

The term “radial” especially refers in the present case to a main axis or rotational axis of the turbomachine or refers to a direction which is perpendicular to a main axis or rotational axis of the turbomachine.

In one embodiment, the vane airfoil has a leading edge and a trailing edge which are interconnected by a suction side and a pressure side.

In one embodiment, the vane airfoil has one end face, or two end faces opposite each other, especially radially opposite each other, which delimit, especially radially delimit, the vane airfoil in one further development.

In one embodiment, the vane airfoil has a platform, or two platforms which are opposite each other, especially radially opposite each other, which platform, or of which one or both platforms, in one development adjoin(s) (in each case), especially radially and/or indirectly adjoin(s), the vane airfoil, especially delimit(s) this, and/or communicate(s) with a flow passage of the working fluid or of the turbomachine, or is, or are, designed for this purpose.

In one embodiment, arranged on a side of the end face, or of one or both end faces and/or of the platform, or of one or both platforms (in each case) which are opposite, especially radially opposite, the vane airfoil, is a further, especially radial vane section which adjoins, especially directly and/or radially adjoins, the end face or platform, is especially produced integrally with the vane airfoil, is referred to in the present case as the second vane section without limiting the generality, and in one development can have a bearing surface or at least a part thereof, and together with a first vane section can especially form a bearing surface.

In one embodiment, at least one platform and/or a second vane section is arranged radially between the vane airfoil and a first vane airfoil section.

According to one embodiment of the present invention, the vane airfoil of the guide vane, in one development also the platform, or one or both platforms, and/or the second vane section, or one or both second vane sections, of the guide vane is, or are, produced completely or partially from one material which in the present case is referred to as the second material without limiting the generality.

The first vane section, or one or both first vane sections, of the guide vane(s) is, or are, according to one embodiment of the present invention produced from a material which is different from this second material and which in the present case is referred to as the first material without limiting the generality.

As the first material, for example a material which is known under the trade name INCONEL® 718 can be used. As the second material on the other hand, for example a material which is known under the trade name MAR-M-247™ can be used. The first material can be a forging material whereas the second material can be a casting material.

In this case, in one embodiment the two first vane sections of the guide vane can be produced from the same (first) material which is different from the second material. In another embodiment, a first vane section can also be produced from the first material and the other first vane section can be produced from the second material or from a (third) material which is different from the first and second materials.

As a result of this, in one embodiment the vane airfoil on the one hand and the first vane section(s) on the other hand can advantageously be adapted to different requirements. Additionally or alternatively, in one embodiment the production of the guide vane can be improved as a result of this.

In one embodiment, the second material features metal and/or a superalloy, or it can especially consist completely or partially thereof. Additionally or alternatively, the second material in one embodiment is designed or suitable for high heat resistance, especially for operating temperatures of at least about 500° C., especially of at least about 800° C.

As a result of this, in one embodiment the vane airfoil can advantageously interact with a working fluid of the turbomachine, can especially stand up to a stress, especially thermal stress, caused by this, or can be designed for this, especially in a turbine stage in one embodiment.

In one embodiment, the first material, also the third material in one development, features metal and/or no superalloy and/or is not resistant to high heat, especially not designed or suitable for operating temperatures of at least 1000° C., especially of at least 800° C.

As a result of this, in one embodiment a first vane section which is produced from the first or third material can especially have advantageous machining properties and/or bearing properties.

In one embodiment, a yield limit or 0.2% offset yield strength (Rₑ or R_{p,0.2}[N/mm²]) of the second material is at least about 1.1 times, especially at least about 1.5 times, a yield limit and/or 0.2% offset yield strength of the first material, also of the third material in one development. Additionally or alternatively, in one embodiment a density (ρ[kg/m³]) of the second material is at least about 1.1 times, especially at least about 1.5 times, a density of the first material, also of the third material in one development.

As a result of this, in one embodiment the vane airfoil on the one hand and the first vane section(s) on the other hand can advantageously be adapted to different requirements. In particular, as a result of a lighter first (or third) material an (overall) weight of the guide vane can be reduced.

In one embodiment, the first vane section, or at least one first vane section, which in particular is produced from the first material is machined by cutting and/or has one or more threads.

As a result of this, in one embodiment an advantageous bearing surface and/or interface, by which the guide vane is connected to an adjustment device for adjusting the guide vane, can especially be created, standard parts such as nuts or the like being able to be used for the connecting.

In one embodiment, the first vane section, or at least one first vane section, which in particular is produced from the first material is joined, especially in a materially bonding manner, especially to the vane airfoil, especially to one end face of the vane airfoil, to a platform of the guide vane which especially adjoins the vane airfoil, or to a second vane section which especially adjoins an end face or platform, and/or is joined by means of welding, especially friction welding or spin welding.

Equally, other joining methods can also be advantageously used. Therefore, a first vane section which in particular is produced from the first material, in one embodiment can also be joined by other welding processes, by soldering, by adhesive fastening, by pressing, by shrinking or the like especially to an end face of the vane airfoil, to a platform of the guide vane which especially adjoins the vane airfoil, or to a second vane section which especially adjoins the end face or platform. Equally, a first vane section which in particular is produced from the first material can also be connected to the end face or platform or to the second vane section in a form-fitting and/or frictionally engaging manner, especially screwed, and/or by corresponding material change can be produced by means of a generative process together with the vane airfoil, the platform or the second vane section.

As a result of this, in one embodiment, vane airfoil and first vane section(s) can advantageously especially be connected in a simple, rigid, process-safe and/or reliable manner.

In one embodiment, the first vane section, or at least one first vane section, which in particular is produced from the first material, has a radial end of the guide vane and/or an especially circumferential bearing surface of the guide vane and/or an interface of the guide vane especially for the connecting of an adjustment device for adjusting the guide vane, or at least a part thereof, in a non-destructively releasable and/or form-fitting and/or frictionally engaging manner.

As a result of this, in one embodiment at least one radial end and/or a bearing surface and/or interface of the guide vane can be advantageously formed, especially advantageously machined.

In one embodiment, the first vane section, or at least one first vane section, which in particular is produced from the first material, adjoins, especially directly and/or radially adjoins, an end face or platform or a second vane section which delimits the vane airfoil and which is arranged on a side of the end face or platform which lies opposite the vane airfoil.

By a first vane section, which in particular is produced from the first material, adjoining the end face or platform, as much weight as possible and/or expensive second material can be saved in one embodiment. By the same token, by a first vane section, which in particular is produced from the first material, (first of all) adjoining the second vane section, in one embodiment a joining point can be advantageously arranged at a distance from the vane airfoil and/or in a bearing surface or on a side of the bearing surface which faces the vane airfoil or faces away from the vane airfoil.

In one embodiment, a radial dimension or height of the first vane section, or of at least one first vane section, which in particular is produced from the first material, is at least about 5%, especially at least about 10% and/or at most about 200%, especially at most about 75%, of a radial dimension or height of the vane airfoil. Additionally or alternatively, in one embodiment a radial dimension or height of the first vane section, or of at least one first vane section, which in particular is produced from the first material, is at least about 5%, especially at least about 10%, and/or at most about 1000%, especially at most about 500%, of a radial dimension or height of the second vane section which is arranged between this first vane section and the vane airfoil.

In one embodiment, the platform, or one or both platforms, is, or are, produced integrally with the vane airfoil.

In one embodiment, the turbomachine has a single-piece or multi-piece casing in which the guide vane is adjustably, especially rotatably or pivotably, mounted. Correspondingly, the variable guide vane in one embodiment is rotatably or pivotably mounted in a casing of the turbomachine, especially in a casing section of a turbine stage or compressor stage of the gas turbine, or is designed for this purpose, especially by means of corresponding bearing surfaces, especially circumferential bearing surfaces A circumferential bearing surface in one embodiment is rotationally symmetrical to the radial direction and/or supports the guide vane in a circumferential and/or axial direction which is perpendicular to the radial direction, or is designed for this purpose.

In one embodiment, the turbomachine has a single-piece or multi-piece adjustment device for especially the mechanical, hydraulic and/or motor-powered adjusting of the guide vane, which adjustment device, especially by its interface, is especially mechanically connected thereto, especially in a form-fitting and/or frictionally engaging manner.

### BRIEF DESCRIPTION OF THE DRAWING

Further advantageous refinements of the present invention are gathered from the dependent claims and from the following description of preferred embodiments. For this purpose, partially schematized in the single drawing:

FIG. 1 shows an adjustable guide vane of a turbomachine according to an embodiment of the present invention.

### DETAILED DESCRIPTION OF EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawing making apparent to those of skill in the art how the several forms of the present invention may be embodied in practice.

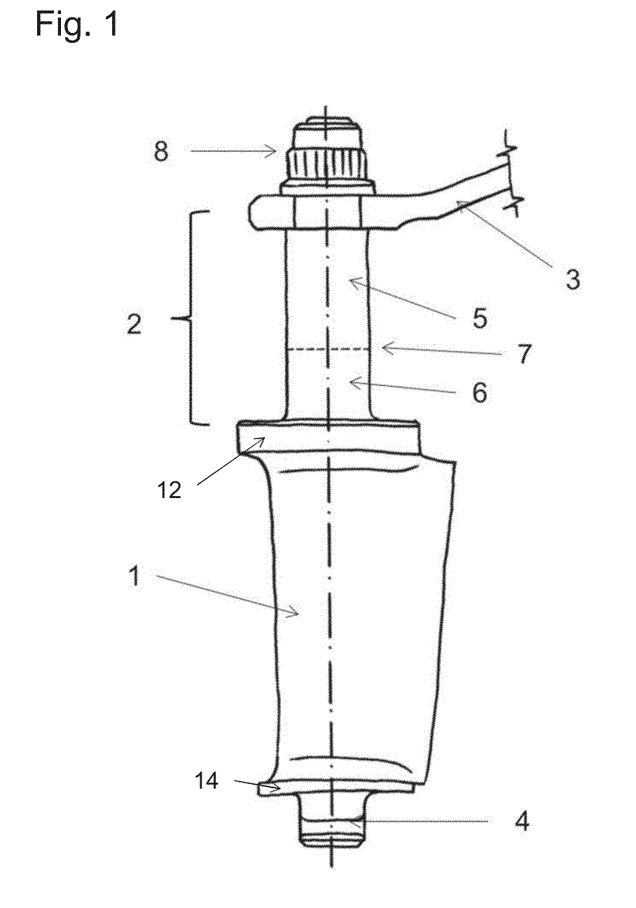

FIG. 1 shows an adjustable guide vane of a turbomachine according to an embodiment of the present invention.

This adjustable guide vane has a vane airfoil 1 for deflecting a working fluid of the turbomachine and also an upper or radially outer hearing region 2 and a lower or radially inner bearing region 4 for the adjustable mounting of the guide vane in a casing (not shown) of the turbomachine, which bearing regions are arranged on sides of the vane airfoil 1 which are radially (vertically in FIG. 1) opposite each other.

The vane airfoil 1 and also these delimiting platforms 12, 14 and a second vane section 6, which radially and directly adjoins the radially outer platform 12, are produced integrally from a second material, especially from a high heat-resistant superalloy.

A radially inner first vane section in the form of the radially inner bearing region 4 and also a radially outer first vane section 5, which together with the second vane section 6 forms the circumferential bearing surface of the radially outer bearing region 2 and also has an interface adjoining it for connecting to an adjustment device 3 for adjusting the guide vane and a radially outer end of the guide vane with a thread upon which a nut 8 is screwed for the fastening of the adjustment device 3, are produced in each case from a first material which is different from the second material, especially from a material which compared with the high heat-resistant superalloy has better cuttability and/or a lower specific weight. In one variation, the radially inner or outer first vane section can also be produced from the second material or from a third material which is different from the first and second materials.

In a materially bonding manner, by friction welding, the radially inner first vane section 4 is joined to the radially inner platform 14 and the radially outer first vane section 5 is joined at a joining point 7 to the second vane section 6.

Although in the preceding description exemplary embodiments were explained, reference may be made to the fact that a large number of variations are possible. Reference may also be made to the fact that the exemplary embodiments are only examples which are in no way intended to limit the extent of protection, the applications and the construction. Rather, as a result of the preceding description a guideline is given to the person skilled in the art for the implementation of at least one exemplary embodiment, wherein diverse modifications, especially with regard to the function and arrangement of the described components, can be undertaken without departing from the extent of protection as gathered from the claims and these equivalent feature combinations.

### LIST OF REFERENCE NUMERALS

1 Vane airfoil

2 Radially outer bearing region

3 Adjustment device

4 Radially inner bearing region

5 Radially outer first vane section

6 Second vane section

7 Joining point

8 Nut

what is claimed is:

1. An adjustable guide vane for a turbomachine, wherein the vane comprises a vane airfoil, produced at least partially from a second material, for deflecting a working fluid of the turbomachine and, and at least one first vane section produced from a first material which is different from the second material.

2. The adjustable guide vane of claim 1, wherein the vane comprises two first vane sections which are arranged on sides of the vane airfoil which are opposite each other, at least one of the first vane sections being produced from the first material which is different from the second material.

3. The adjustable guide vane of claim 1, wherein the second material features metal and/or a superalloy and/or is resistant to high heat.

4. The adjustable guide vane of claim 1, wherein the first material features metal and/or no superalloy and/or is not resistant to high heat.

5. The adjustable guide vane of claim 1, wherein a yield limit or 0.2% offset yield strength of the second material is at least about 1.1 times a yield limit or 0.2% offset yield strength of the first material.

6. The adjustable guide vane of claim 1, wherein a density of the second material is at least about 1.1 times a density of the first material.

7. The adjustable guide vane of claim 1, wherein a density of the second material is at least about 1.5 times a density of the first material.

8. The adjustable guide vane of claim 1, wherein at least one first vane section is machined by cutting and/or has at least one thread.

9. The adjustable guide vane of claim 8, wherein the at least one first vane section is produced from the first material.

10. The adjustable guide vane of claim 1, wherein at least one first vane section is joined in a materially bonding manner

11. The adjustable guide vane of claim 10, wherein the at least one first vane section is produced from the first material.

12. The adjustable guide vane of claim 10, wherein the at least one first vane section is joined by welding.

13. The adjustable guide vane of claim 1, wherein at least one first vane section comprises a radial end and/or at least a part of a bearing surface and/or of an interface for connection of an adjustment device for adjusting the guide vane.

14. The adjustable guide vane of claim 13, wherein the at least one first vane section is produced from the first material.

15. The adjustable guide vane of claim 1, wherein at least one first vane section adjoins an end face or platform which delimits the vane airfoil or adjoins a second vane section which is arranged on a side of the end face or platform which is opposite the vane airfoil.

16. The adjustable guide vane of claim 15, wherein the at least one first vane section is produced from the first material.

17. The adjustable guide vane of claim 15, wherein the platform and/or the second vane section is produced at least partially from the second material.

18. The adjustable guide vane of claim 17, wherein the platform and/or the second vane section is produced integrally with the vane airfoil.

19. A turbomachine, wherein the turbomachine comprises a casing, at least one adjustable guide vane according to claim 1 that is adjustably mounted in the casing, and an adjustment device which is connected thereto for adjusting the guide vane.

20. A method for producing the adjustable guide vane of claim 1, wherein the method comprises producing the vane airfoil from the second material; producing at least one first vane section from the first material, and connecting the vane airfoil in a materially bonding manner to the at least one first vane section.
